(19) United States
(12) Patent Application Publication
(10) Pub. No.: US 2018/0130123 A1
(43) Pub. Date: May 10, 2018

(54) CUSTOMIZING CONSUMPTION OF VEHICLE USE USING VEHICLE TELEMATICS

(71) Applicant: GENERAL MOTORS LLC, DETROIT, MI (US)

(72) Inventors: Gregory A. Ross, Beverly Hills, MI (US); Tyson Becker, Northville, MI (US)

(21) Appl. No.: 15/344,153

(22) Filed: Nov. 4, 2016

(51) Int. Cl. G06Q 30/06; G06Q 20/14; G06Q 20/10

(52) U.S. Cl. CPC G06Q 30/0645; G06Q 50/30; G06Q 20/102; G06Q 20/145

(57) ABSTRACT

A system and method of customizing consumption of vehicle use includes: receiving, at a remote facility, a lease notification that includes a vehicle identifier; determining, at the remote facility, contact information for a vehicle based on the vehicle identifier; wirelessly transmitting a trigger from the remote facility to the vehicle, wherein the trigger directs the vehicle to monitor vehicle performance during a vehicle lease associated with the vehicle; wirelessly receiving vehicle data representing vehicle performance at the remote facility from the vehicle based on the trigger; and determining a payment value of a vehicle lease associated with the vehicle based on the vehicle data wirelessly received from the vehicle.

### INTRODUCTION

The present invention relates to vehicle telematics and, more particularly, to customizing the consumption of vehicle use using vehicle telematics.

Vehicle users lease a vehicle according to terms that are generally fixed. For example, a vehicle lease may have a defined term (e.g., thirty-six months) during which the user can drive the vehicle no more than 30,000 miles. Lease term and mileage have generally been relied on as accurate predictors of vehicle degradation, often referred to loosely as “wear and tear.” However, existing lease term and mileage constraints are often poorly matched with the way vehicle users consume vehicle usage. For instance, vehicle users may drive the vehicle far less than 30,000 miles in three years but then pay for more vehicle use than they actually consume.

In the past, the vehicle user or lessee would drive the vehicle to a vehicle dealership where the vehicle odometer would be examined to see if the vehicle mileage fell under the mileage limit agreed to as part of the lease. This examination occurred only once—at the end of the lease when the user surrendered the vehicle to a vehicle dealer or lessor. The dealer/lessor may access the vehicle mileage from an on-board computer by physically attaching a vehicle scan tool to an On-board Diagnostic (OBD) system port to receive an accurate mileage reading. However, the infrequent dealership examination of leased vehicles at the time the vehicle lease ends can be time consuming and yield little data about how the vehicle is used in between the time the vehicle dealership delivered the vehicle until the lessee returns the vehicle to the vehicle dealership.

### SUMMARY

According to an embodiment of the invention, there is provided a method of customizing consumption of vehicle use with vehicle telematics. The method includes receiving, at a remote facility, a lease notification that includes a vehicle identifier; determining, at the remote facility, contact information for a vehicle based on the vehicle identifier; wirelessly transmitting a trigger from the remote facility to the vehicle, wherein the trigger directs the vehicle to monitor vehicle performance during a vehicle lease associated with the vehicle; wirelessly receiving vehicle data representing vehicle performance at the remote facility from the vehicle based on the trigger; and determining a payment value of a vehicle lease associated with the vehicle based on the vehicle data wirelessly received from the vehicle.

According to another embodiment of the invention, there is provided a method of customizing consumption of vehicle use with vehicle telematics. The method includes receiving, at a remote facility, a lease notification that includes a vehicle identifier; determining, at the remote facility, contact information for a vehicle based on the vehicle identifier; wirelessly transmitting a trigger from the remote facility to the vehicle, wherein the trigger directs the vehicle to monitor an amount of mileage accumulated by the vehicle during at least a portion of a vehicle lease associated with the vehicle; wirelessly receiving at the remote facility the amount of mileage accumulated; determining a payment value of the vehicle lease associated with the vehicle based on the amount of mileage wirelessly received from the vehicle; and sending the payment value of the vehicle lease to a vehicle lessee.

According to yet another embodiment of the invention, there is provided a method of customizing consumption of vehicle use with vehicle telematics. The method includes receiving, at a remote facility, a lease notification that includes a vehicle identifier; sending a base payment value of a vehicle lease to a vehicle lessee; receiving a payment for the base payment value of the vehicle lease from the vehicle lessee; determining, at the remote facility, contact information for the vehicle based on the vehicle identifier; wirelessly transmitting a trigger from the remote facility to the vehicle, wherein the trigger directs the vehicle to monitor an amount of mileage accumulated by the vehicle during at least a portion of the vehicle lease; wirelessly receiving at the remote facility the amount of mileage accumulated; comparing the amount of mileage with a mileage allowance; and providing a mileage credit when the amount of mileage is below the mileage allowance.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of customizing consumption of vehicle use.

### DETAILED DESCRIPTION

The system and method described below facilitates customized consumption of vehicle use with vehicle telematics. Vehicle users or vehicle lessees can lease a vehicle at a vehicle dealership without agreeing to a fixed payment per month during the term of the lease. Instead, the user can agree to compensate the vehicle lessor for only the actual vehicle use or consumption that occurs based on vehicle data wirelessly received from the leased vehicle. For example, a remote facility can receive a lease notification indicating that a vehicle has been leased, which includes a vehicle identifier uniquely identifying that vehicle. The remote facility can access contact information for that vehicle based on the vehicle identifier and wirelessly transmit a trigger to the vehicle directing it to monitor vehicle performance during the vehicle lease. The trigger can cause a vehicle telematics unit on the vehicle to periodically transmit vehicle data to the central facility for determining payment values to be made by the vehicle user. This data can be received at the central facility and payment values can be calculated periodically throughout the lease according to one of a variety of schedules.

### Communications System—

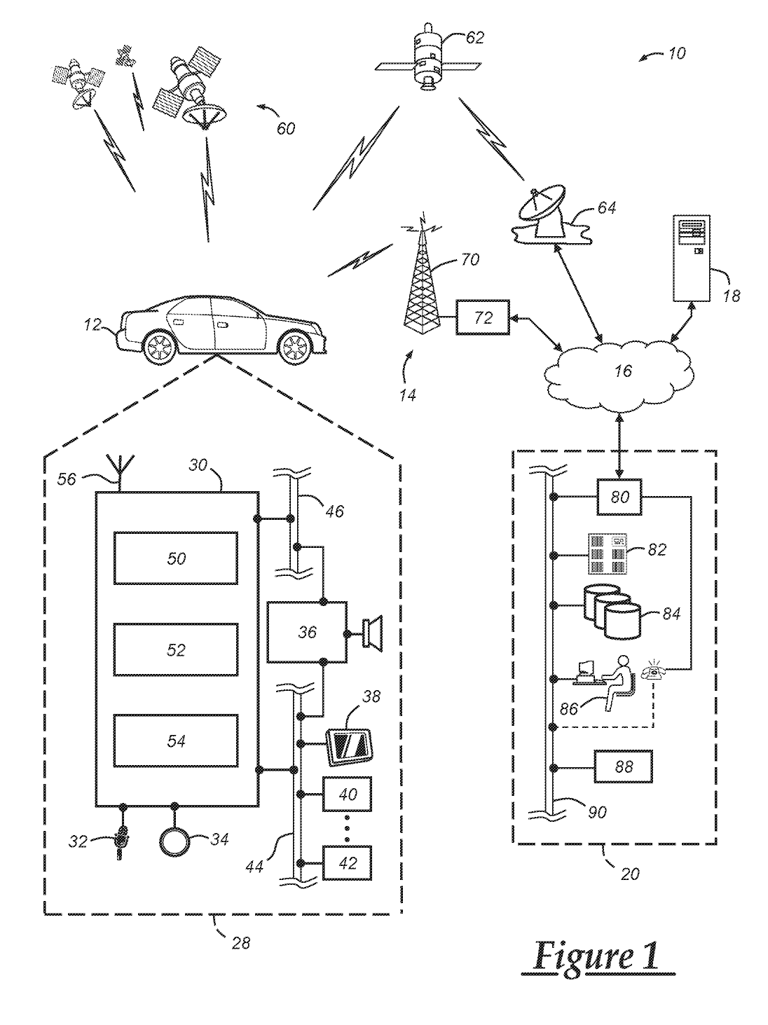

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. The computer 18 can receive data messages from a vehicle delivery location, such as a vehicle dealership, where vehicles are delivered or serviced. A computer 18 can also be used for providing Internet connectivity such as DNS services or as a network address server that uses DHCP or other suitable protocol to assign an IP address to the vehicle 12. And the computer 18 can include a memory device suitable for storing a database that can be searched as well as written to or otherwise modified with new data using the processor of the computer 18.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

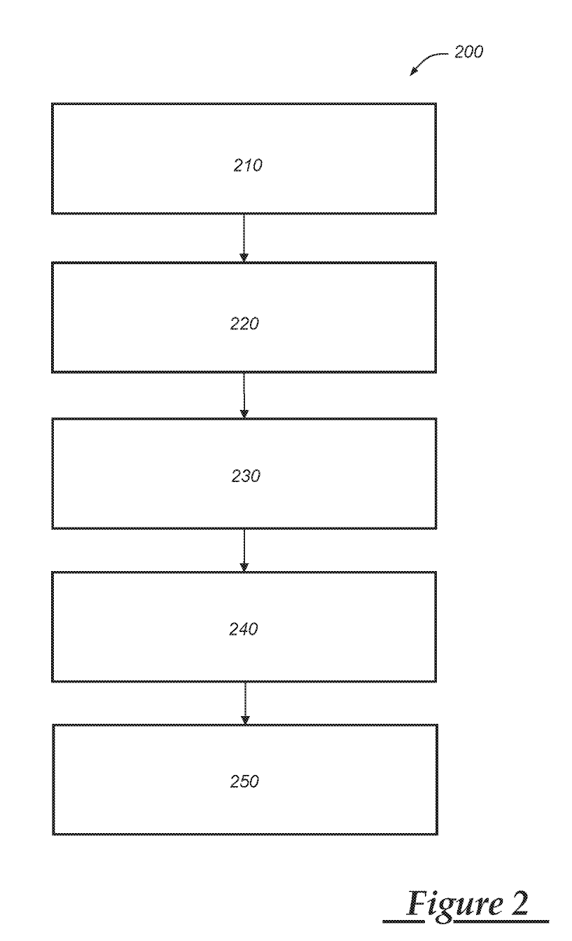

Turning now to FIG. 2, there is shown an implementation of a method 200 of customizing consumption of vehicle use with vehicle telematics. The method 200 begins at step 210 by receiving, at a remote facility, a lease notification that includes a vehicle identifier. When a vehicle lessee or user leases the vehicle 12, a vehicle dealer or other entity that initially received the vehicle 12 from a vehicle manufacturer can transmit a data message to the remote facility identifying the vehicle 12 and indicating that it has been leased. Some vehicle dealers may lease a plurality of vehicles daily and transmit a data message that includes the identities of a plurality of vehicles, initial mileage for those vehicles, the purchase date for each vehicle, and whether or not the vehicle lessee has selected a fixed lease or customized consumption lease. The data message sent from the vehicle dealership to the remote facility can also include the identities of a plurality of vehicles that have been returned to the vehicle dealership at the end of a lease, an existing mileage for those vehicles, and the return date for each vehicle.

The remote facility can read data messages received from vehicle dealership(s) and begin to remotely monitor the vehicles that have been identified as being leased. The method 200 will be described with respect to the lease of vehicle 12, however, it should be appreciated that the methods described herein can be designed to accommodate large numbers of leased vehicles, such as all of the vehicles produced by a vehicle manufacturer. Also, the remote facility can be implemented in a variety of ways. For example, the remote facility can be implemented by the computer 18 or call center 20. With respect to the lease of vehicle 12, the data message can include a vehicle identification number (VIN) that identifies vehicle 12, which the remote facility can store in a database.

The database may be accessible by the remote facility and can include a memory device or structure that identifies vehicles and associates vehicle lessee information with those vehicles. Vehicle lessee information can be associated with the VIN and include the name of the lessee, information for contacting the lessee, as well as vehicle data representing vehicle performance. Contact information that can be used to contact the vehicle 12 and wirelessly transmit triggers to the vehicle 12 can also be stored in the database as well. The vehicle contact information can include a mobile dialed number (MDN) that is associated with the vehicle telematics unit 30 of the vehicle 12 and dialed by the remote facility to contact the vehicle 12. The remote facility can read the data message and determine whether or not the vehicle lease is a fixed lease or alternatively whether the vehicle lessee has chosen to determine payment values based on the actual use of the vehicle 12. If the vehicle lease is fixed, the method 200 ends. Otherwise, the information included in the data message can be stored as an entry in a database by the remote facility, which can begin monitoring the vehicle 12. The method 200 proceeds to step 220.

At step 220, contact information for the vehicle is determined at the remote facility based on the vehicle identifier. After receiving the data message and determining that the vehicle 12 is subject to a lease with customized consumption such that the payment values of that lease are variable, the remote facility can access the contact information for the vehicle 12. For instance, the remote facility can use the VIN for the vehicle 12 to access a data entry in the database and determine the MDN for the vehicle 12. The MDN can then be used by the remote facility to place a cellular call to the vehicle telematics unit 30 of the vehicle 12 via the wireless carrier system 14. The method 200 proceeds to step 230.

At step 230, a trigger is wirelessly transmitted from the remote facility to the vehicle 12. The trigger directs the vehicle 12 to monitor vehicle performance during a vehicle lease associated with the vehicle 12. For example, the vehicle 12 can be instructed by the trigger to wirelessly transmit vehicle mileage that has accrued during a determined amount of time to the remote facility. The trigger can be a computer-readable instruction received by the vehicle telematics unit 30 and executed using its processor 52. And the trigger can be configured to execute a variety of instructions depending on implementation. For example, the trigger may include an instruction for the vehicle telematics unit 30 to monitor vehicle mileage the vehicle 12 has traveled each day and record that mileage in the memory devices 54. The instruction can then direct the vehicle telematics unit 30 to initiate a call to the remote facility daily, each week, monthly, bi-annually, or annually that may be used to wirelessly communicate the stored vehicle mileage to the remote facility. Or in another example, the remote facility can wirelessly transmit a trigger to the vehicle telematics unit 30 each day directing it to wirelessly transmit the mileage the vehicle 12 has travelled in the past 24 hours. The method 200 proceeds to step 240.

At step 240, vehicle data representing vehicle performance is wirelessly received at the remote facility from the vehicle 12 based on the trigger. Periodically, depending on the instruction included in the trigger, the remote facility will receive vehicle data from the vehicle. As discussed above, this data can indicate the mileage the vehicle has traveled or accumulated for a defined period of time. The vehicle data been transmitted with a vehicle identifier, such as the VIN, and the remote facility can access a corresponding vehicle identifier in the database and store the mileage data so that it is associated with the vehicle identifier. The method 200 proceeds to step 250.

At step 250, a payment value of the vehicle lease associated with the vehicle 12 is determined based on the vehicle data wirelessly received from the vehicle 12. Depending on the terms of the vehicle lease, the vehicle lessee can be obligated to pay a variable payment value based on vehicle performance data received from the vehicle 12. In one implementation, a payment value of the vehicle lease associated with the vehicle is determined based on the amount of mileage the vehicle 12 has traveled per unit time. For example, if a vehicle lease for the vehicle 12 has a term of three years, the payment value can be determined monthly based on a cost-per-mile rate. Each month, the remote facility can determine the amount of miles the vehicle 12 has traveled and multiply the amount of miles by the cost-per-mile rate to determine the payment value the vehicle lessee will pay that month. Based on the example of the three year lease, the remote facility can determine the amount of miles the vehicle 12 has traveled each month and customize the monthly payment amounts according to the miles the vehicle 12 has travelled. For example, if the remote facility determines that the vehicle 12 travelled 500 miles during a month and a cost-per-mile agreed to in the vehicle lease is listed at $0.20 a mile, the payment value can be determined to be $100. Is it also possible to calculate the payment amounts more or less frequently that monthly. To reduce the amount of data transmitted between the vehicle 12 and the remote facility, the payment value could be calculated every six months (i.e., semi-annually). That way the vehicle 12 may transmit the mileage traveled less than if the payment values were calculated monthly. Further, the cost-per-mile value can vary inversely with the amount of mileage traveled by the vehicle 12. Rather than the fixed rate of $0.20 per mile, the cost-per-mile rate could be $0.25 for the first 250 miles, $0.20 for miles 250-500, and $0.18 for miles over 500.

Another implementation involves a lease with a preliminary payment value that can be adjusted upwards or downwards based on the mileage traveled by the vehicle 12. For example, using the three-year lease example, the vehicle lessee may have agreed to a base payment of $500 per month for thirty-six months with a base mileage allowance of 10,000 miles. The remote facility can adjust this payment based on the miles the vehicle 12 travels each month. When the base mileage allowance of 10,000 is divided by the thirty-six months of the lease, the vehicle lessee receives a monthly mileage allowance of slightly more than 833 miles per month. At the end of each month, the remote facility can access the mileage traveled by the vehicle 12 and compare it to the monthly mileage allowance. If the mileage falls below the monthly mileage allowance, the remote facility can generate mileage credit for the vehicle 12 that is received by the vehicle lessee. That is, the actual mileage traveled by the vehicle 12 can be subtracted from the monthly mileage allowance to determine unused mileage. And the unused mileage can be multiplied by a cost-per-mile credit to determine a mileage credit.

To illustrate a possible monthly mileage credit, the remote facility may determine that the vehicle 12 has been driven 500 miles during a month. The remote facility can then calculate that 333 miles have been unused and multiply those miles by a cost-per-mile credit, such as $0.10 per mile. This yields a $33.30 mileage credit for the vehicle lessee. The remote facility can apply that credit to the base payment for this or following months so that the vehicle lessee receives a payment value of $467.70 rather than the $500 base payment value. However, the remote facility could alternatively store the $33.30 credit along with the vehicle identifier in the database. Considering that the mileage the vehicle travels over time may fluctuate, so too may the mileage credit rise or fall as time passes and the remote facility may choose not to adjust the base payment every month but wait and do so quarterly, semi-annually, or annually. This adjustment can be downwards using the mileage credit or even upwards if the mileage traveled by the vehicle 12 exceeds the monthly mileage allowance. The mileage credit need not be issued in currency form but rather could be generated as a credit for purchasing vehicle service or for a lease/purchase of a new vehicle.

Other types of vehicle data can alternatively or additionally be used to determine payment values. For example, the vehicle data can include information about vehicle maintenance (e.g., oil life monitoring), vehicle usage (e.g., engine use, braking use, hard accelerations, vehicle location (i.e., southern climates during the summer or northern climates during the winter), and vehicle severe events (e.g., accidental events or catastrophic events, such as a flood or hurricane).

The remote facility can then send the determined payment value of the vehicle lease to the vehicle lessee. The determined payment value can be generated electronically and included in an electronic message that is accompanied by other vehicle-related information. For example, the electronic message, such as an email message, can include vehicle-lease-related information. The vehicle-lease-related information can include information such as the base payment, base mileage allowance, unused mileage, and mileage credit. It is also possible to include vehicle diagnostic information with the payment value. Information relating to tire pressure values, oil life, outstanding recall notices, diagnostic trouble codes (DTCs) can also be included in the electronic message along with the vehicle-lease-related information and sent to the vehicle lessee. In some implementations, the information included in the electronic message can be printed on an invoice and sent to the vehicle lessee using a postal service. The remote facility can access vehicle lessee contact information stored in the database along with the vehicle identifier and use that information to send the payment value. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of customizing consumption of vehicle use with vehicle telematics, comprising the steps of:
(a) receiving, at a remote facility, a lease notification that includes a vehicle identifier;
(b) determining, at the remote facility, contact information for a vehicle based on the vehicle identifier;
(c) wirelessly transmitting a trigger from the remote facility to the vehicle, wherein the trigger directs the vehicle to monitor vehicle performance during a vehicle lease associated with the vehicle;
(d) wirelessly receiving vehicle data representing vehicle performance at the remote facility from the vehicle based on the trigger; and
(e) determining a payment value of a vehicle lease associated with the vehicle based on the vehicle data wirelessly received from the vehicle.

2. The method of claim 1, wherein the lease notification includes a data entry indicating the vehicle lease is not a fixed term lease.

3. The method of claim 1, wherein the contact information for the vehicle is stored at the remote facility in a database.

4. The method of claim 1, where in the vehicle performance comprises an amount of mileage traveled by the vehicle.

5. The method of claim 1, wherein step (e) further comprises:
determining a cost-per mile value for the vehicle lease; and
calculating the payment value for a portion of the lease based on the cost-per-mile value and the mileage of the vehicle during the portion of the lease.

6. The method of claim 1, further comprising the step of sending the payment value to the vehicle lessee.

7. The method of claim 6, wherein vehicle diagnostic information is included along with the payment value.

8. A method of customizing consumption of vehicle use with vehicle telematics, comprising the steps of:
(a) receiving, at a remote facility, a lease notification that includes a vehicle identifier;
(b) determining, at the remote facility, contact information for a vehicle based on the vehicle identifier;
(c) wirelessly transmitting a trigger from the remote facility to the vehicle, wherein the trigger directs the vehicle to monitor an amount of mileage accumulated by the vehicle during at least a portion of a vehicle lease associated with the vehicle;
(d) wirelessly receiving at the remote facility the amount of mileage accumulated;
(e) determining a payment value of the vehicle lease associated with the vehicle based on the amount of mileage wirelessly received from the vehicle; and
(f) sending the payment value of the vehicle lease to a vehicle lessee.

9. The method of claim 8, wherein the lease notification includes a data entry indicating the vehicle lease is not a fixed term lease.

10. The method of claim 8, wherein the contact information for the vehicle is stored at the remote facility in a database.

11. The method of claim 8, where in the vehicle performance comprises an amount of mileage traveled by the vehicle.

12. The method of claim 8, wherein step (e) further comprises:
determining a cost-per mile value for the vehicle lease; and
calculating the payment value for a portion of the lease based on the cost-per-mile value and the amount of mileage accumulated during the portion of the lease.

13. The method of claim 8, wherein vehicle diagnostic information is included along with the payment value.

14. A method of customizing consumption of vehicle use with vehicle telematics, comprising the steps of:
(a) receiving, at a remote facility, a lease notification that includes a vehicle identifier;
(b) sending a base payment value of a vehicle lease to a vehicle lessee;
(c) receiving a payment for the base payment value of the vehicle lease from the vehicle lessee;
(d) determining, at the remote facility, contact information for the vehicle based on the vehicle identifier;
(e) wirelessly transmitting a trigger from the remote facility to the vehicle, wherein the trigger directs the vehicle to monitor an amount of mileage accumulated by the vehicle during at least a portion of the vehicle lease;
(f) wirelessly receiving at the remote facility the amount of mileage accumulated;
(g) comparing the amount of mileage with a mileage allowance; and
(h) providing a mileage credit when the amount of mileage is below the mileage allowance, wherein steps (b)-(c) are carried out before steps (f)-(h).

15. The method of claim 14, wherein the lease notification includes a data entry indicating the vehicle lease is not a fixed term lease.
